(19) United States
(12) Patent Application Publication
(10) Pub. No.: US 2005/0180830 A1
(43) Pub. Date: Aug. 18, 2005

(54) Z-axis measurement tool for vertical milling machines

(76) Inventor: Dwayne A. Tieszen, Ponder, TX (US)

Correspondence Address: Richard C. Litman;LITMAN LAW OFFICES, LTD., P.O. Box 15035, Arlington, VA, 22215, US

(21) Appl. No.: 10/778,389

(22) Filed: Feb. 17, 2004

(51) Int. Cl. B23C 1/12

(52) U.S. Cl. 409/218

(57) ABSTRACT

The “Z”-axis measurement tool is an adapter having a mounted depth gage for precise measurement of the vertical displacement of the cutting edge of a vertical milling machine. The tool has a first magnetically mountable bracket slidably attached to a stationary portion of a vertical milling machine, and a second bracket removably mounted to the quill stop of the milling machine. A depth gage mounted to the first bracket has an upward extending spindle which cooperatively engages a flat surface on the second bracket when the quill stop descends as the quill is lowered to engage a workpiece with a cutter.

### BACKGROUND OF THE INVENTION

1. Field of the Invention

The present invention relates generally to attachments for machine tools. More particularly, the Z-axis measurement tool relates to a holder assembly for an indicator for use with vertical milling machines to measure the vertical travel, or milling depth, of a quill mechanism.

2. Description of the Related Art

Milling machines are used for removing metal from a workpiece, and a number of different types of milling machines are commercially available. These commercially available milling machines often are classified as either vertical or horizontal. In the horizontal milling machines, the rotating spindle is oriented horizontally. In a vertical milling machine, the rotating spindle is vertically disposed, typically for face milling and end milling.

The vertical milling machine is a versatile shop tool. For example, in a knee and column machine, a worktable is movably mounted on a saddle, which is movably mounted on the knee. The milling head is disposed above the worktable. The head may be fixed, or movable 90° to the left or right for cutting tapered holes, slots, cutouts, and the like, or movable vertically. The head may also be mounted on an overarm or ram which is rotatably mounted in a turret, so that the milling head may be positioned anywhere over the worktable. For typical face milling and end milling, the worktable can be moved from side to side horizontally across the machine (the X-axis), toward or away from the machine horizontally (the Y-axis), or vertically towards the cutting head. Usually the worktable is adjusted and locked along the Y-axis to set the position of the cut, and adjusted and locked vertically along the Z-axis to set the depth of the cut. A power feed mechanism moves the worktable longitudinally along the X-axis to mill the workpiece.

The vertical milling machine can also be used for drilling, boring, reaming, and other such operations by moving the cutting head, or a quill mechanism attached to the head, vertically along the Z-axis. With a quill mechanism, the cutter is mounted in a spindle driven by the motor. The spindle is mounted in a hollow quill which can be raised and lowered either by servo motors or manually with a quill lever, similar to operation of a drill press. The degree of quill travel is set by adjusting a micrometer adjusting nut on a threaded rod.

One problem with conventional vertical milling machines is that the scales, including dials and pointers, provided with the handcranks and micrometer adjusting nut provide only for close approximation of the table and head position. Consequently, they are inadequate when fine tolerances are required. Digital read-out (DRO) equipment is available either as original equipment or an after-market addition to improve cutting tolerances. However, due to the cost of DRO equipment, many manufacturing establishments and metalworking shops are only installed for adjustments along the X-axis and the Y-axis, the incremental cost for a DRO for the Z-axis being prohibitive. In addition, DRO's frequently are designed for use with Bridgeport brand or Bridgeport type mills only.

Consequently, there is a need for a Z-axis measurement tool for vertical milling machines that is more economical and cost-effective that DRO equipment. There is also a need for a Z-axis measurement tool that is more universal than a DRO, being adapted for use with a greater variety of vertical milling machine brands. There is a further need for a Z-axis measurement tool that can be furnished as an after-market addition to a conventional vertical milling machine, or as original equipment, as desired.

Some efforts have been made alleviate this problem by providing various quill control mechanisms. For example, U.S. Pat. No. 5,330,298, issued to Welch et al. in July 1994, teaches the positioning of controlling elements so that both manual positioning of the quill and automatic positioning of the quill can be achieved. Other efforts have been directed towards position indicating mechanisms. For example, U.S. Pat. No. 4,909,683, issued to Vershowske et al. in March 1990, describes a scale adapted to provide a highly accurate digital readout of the linear position of a quill.

U.S. Pat. No. 6,071,050, issued to Patrick et al. in June 2000, discloses a fine feed adjustment adapter for milling machines that is capable of obtaining adjustments between ¼ and 1/10,000^{th} of an inch along the Z-axis.

Still other inventors have conceived of stop assemblies for milling machines to provide quick and accurate adjustments of a stop assembly setting (U.S. Pat. Nos. 5,252,010 and 5,106,242, issued to Obrecht et al.; U.S. Pat. No. 4,521,144 issued to Ginter; U.S. Pat. No. 4,574,441, issued to Kronfeld; U.S. Pat. No. 4,787,794, issued to Guthrie; U.S. Pat. No. 5,947,664, issued to Espinosa; and U.S. Pat. No. 6,039,518, issued to Day).

U.S. Pat. No. 5,286,147, issued to Escobedo et al. in February 1994, discloses an adapter for mounting a depth gage onto a mill head of a vertical milling machine, the adapter having an elongated bracket with an outwardly projecting block for slidably carrying an indicator rod with spaced apart depth grooves. An adjustable anvil is carried on the rod below the markings and has a broad, flat surface cantilevered outwardly beyond the rod and its mounting block in order to cooperatively engage the sensing probe of a conventional depth gage. The depth gage is a dial indicator held on a mounting fixture attached to the quill stop so that the dial indicator moves downward until the spring-biased sensor contacts the anvil.

The '147 device has several important limitations. One disadvantage is that the mounting bracket must be screwed into the machine face, thereby requiring holes to be drilled and tapped into the machine to accept the bracket, or use existing screw holes, if available. Secondly, the dial indicator travels with the quill stop, thereby requiring the operator to accurately observe the descending dial indicator with rotating indicia while trying to perform a precision operation. Third, because the dial indicator is physically attached to the quill stop, it may interfere with other machine operations when not in use. Its attachment screw must be loosened to remove the indicator or the anvil must be relocated. Fourth, accurately adjusting the position of the anvil and tightening the thumbscrew while keeping the cutting tool in contact with the workpiece can be a daunting task, at best.

Another adapter for mounting depth gauges onto milling machines includes U.S. Pat. No. 6,612,790 issued to P. Story Jr., which discloses a retrofit apparatus for attachment to a vertical milling machine. The '790 patent includes a main scale, a digital indicator, a mounting cover, a quill stop bar, a quill mount and a rod. In operation, as the quill device of a milling machine is moved, the indicator slides up and down and the indicator measures the vertical displacement.

Of further interest in the field of indicators for industrial machinery includes U.S. Pat. No. 4,750,699, issued to J. Tingley in June 1988, and U.S. Pat. No. 5,704,132, issued to E. T. Bourne in June 1998.

None of the above inventions and patents, taken either singly or in combination, is seen to describe the instant invention as claimed. Thus, a need exists for an apparatus that provides a precise measurement of the depth or vertical movement of a quill.

### SUMMARY OF THE INVENTION

The Z-axis measurement tool is an adapter having a mounted depth gage for precisely measuring the quill travel of a vertical milling machine. The tool has two brackets made of non-magnetic material, such as plastic or aluminum, that are mountable to the head of a vertical milling machine. A first bracket, referred to as a dial indicator mounting bracket and having mounting points for a dial indicator depth-gage, is magnetically and slidably attached to the milling machine's quill stop micro screw, a stationary portion of the head. The dial indicator mounting bracket attaches to the metallic quill stop micro screw by means of rare-earth magnets embedded in the bracket housing. Advantageously, rare earth magnets are stronger than ordinary iron magnets, and therefore provide a strong magnet in a compact size. The magnets are disposed at locations that maximize the grip of the bracket onto the micro screw. An adjustable magnetic stabilizer arm incorporated in the dial indicator mounting bracket magnetically clamps onto a front plate attached to the head behind the micro screw and serves to minimize rotational deflection of the dial indicator mounting bracket, and to facilitate setting the dial indicator to zero.

A second bracket, referred to as the travel bar, is removably mounted to the vertically traveling quill stop above the first bracket. The travel bar is attached to the quill stop by means of a pinch block having a circular stud which is received by a cavity found in the quill stop of most commercially available milling machines.

A commercially available dial indicator is inverted and mounted to the first bracket with the stem extending upward so that the contact point at the end of the spindle engages a broad flat contact surface on the travel bar in response to the lowering of the quill. Vertical displacement of the dial indicator spindle as a result of contact with the descending travel bar results in a precise visual indication on the face of the dial indicator.

Accordingly, it is a principal object of the invention to provide an economical and accurate Z-axis measurement tool for Z-axis positioning in a vertical milling machine.

It is a further object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is an environmental, perspective view of a Z-axis measurement tool for vertical milling machines according to the present invention, having quill raised and the cutter positioned above the surface of the workpiece and the dial indicator spindle positioned below the travel bar.

FIG. 1B is an environmental, perspective view of the Z-axis measurement tool with the quill lowered and the cutter positioned at the surface of the workpiece and the dial indicator contact abutting the travel bar, the indicator being zeroed by a user.

FIG. 1C is an environmental, perspective view of the Z-axis measurement tool, the cutter penetrating the workpiece and quill travel, or depth of cut, shown on the dial indicator.

FIG. 2 is an environmental, front elevation view of the Z-axis measurement tool.

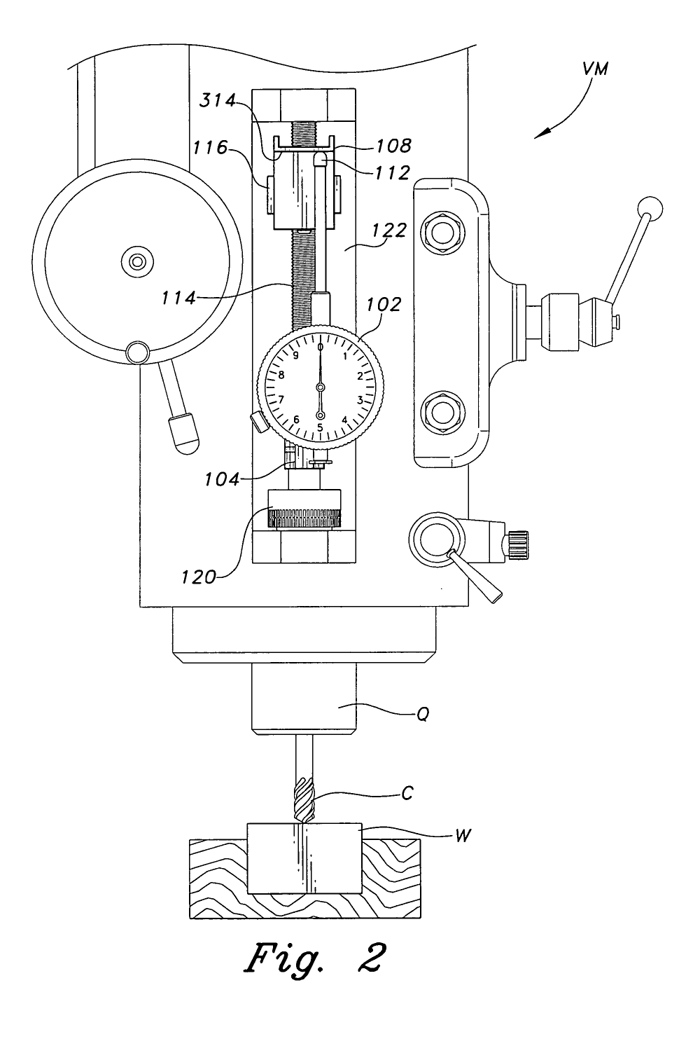

FIG. 3A is a perspective view of the travel bar of the Z-axis measurement tool according to the present invention, as seen from the right front.

FIG. 3B is a perspective view of the travel bar of the Z-axis measurement tool according to the present invention, as seen from the left rear.

FIG. 3C is a rear perspective view of the travel bar of the Z-axis measurement tool according to the present invention, showing adjustment of the tension between the pinch block and base.

FIG. 4A is an exploded, perspective view of the dial indicator mounting bracket of the Z-axis measurement tool according to the present invention.

FIG. 4B is a rear perspective view of the dial indicator mounting bracket according to the present invention.

FIG. 5 is a rear elevation view of the dial indicator mounting bracket of the Z-axis measurement tool according to the present invention.

FIG. 6 is an environmental, perspective view of a vertical milling machine head of the prior art.

Similar reference characters denote corresponding features consistently throughout the attached drawings.

### DETAILED DESCRIPTION OF THE PREFERRED EMBODIMENT

The present invention, designated generally as 100 in the drawings, is a measurement tool having a mounted depth gage 102 of the dial indicator type for precisely measuring the quill travel, and hence the depth of the cutter C along the Z-axis of a vertical milling machine VM.

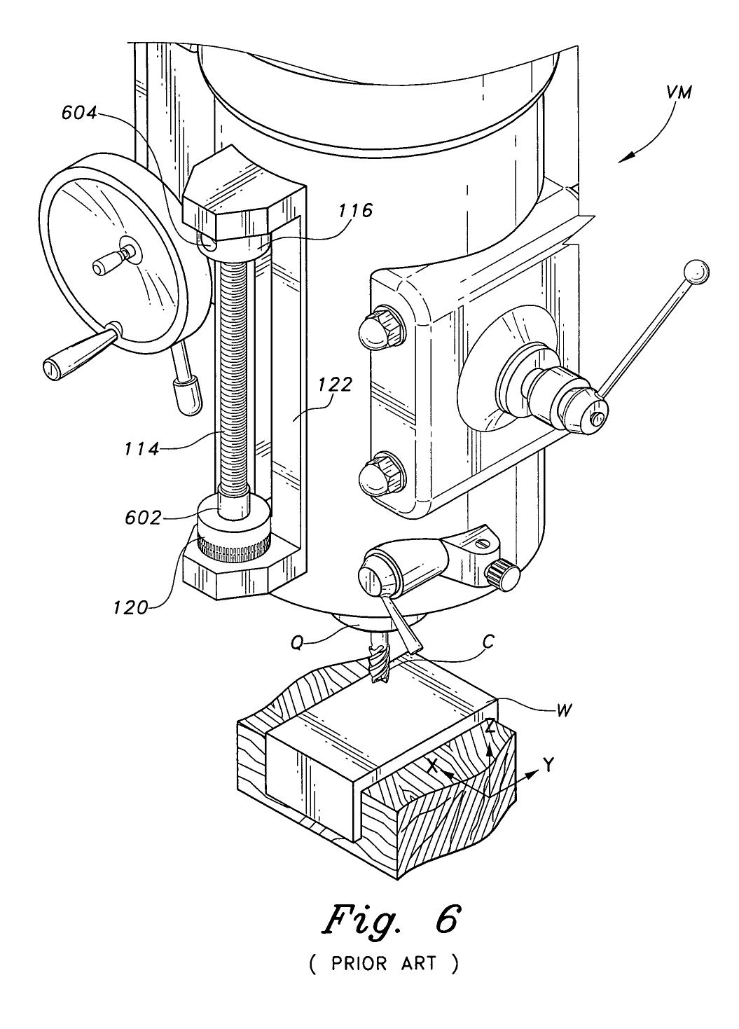

Referring first to FIG. 6, many commercially available vertical milling machines VM, such as those made by Bridgeport Machines, Inc., have, as standard equipment, a mechanism for limiting the vertical displacement or travel of the quill Q as the attached cutter C penetrates into the surface of the workpiece W. This mechanism consists of a quill stop 116, which travels along a vertically oriented quill stop micro screw 114 until a micrometer adjusting nut 120 stops the downward travel of the quill stop 116.

During automatic quill feed, the pressure generated kicks the feed control lever out, thereby stopping automatic quill feed. Automatic quill feed is not often used when close tolerance is needed for depth measurement because of problems with repeatability. The quill handle is then used for manual operation, downward travel of the quill Q stopping when the quill stop 116 stops against the micrometer adjusting nut 120, thereby limiting penetration of the cutter C into the workpiece W.

Even with manual quill feed, however, it is often difficult or impossible to achieve precision and accuracy when close tolerance is required for depth measurements due to the necessity of visually aligning the micrometer adjusting nut 120 with the micrometer scale markings (not shown) on the front plate 122 of the milling head. Adjustment along the X-axis and Y-axis is accomplished by adjustment of the position of the worktable, while for the drilling operation shown, adjustment along the Z-axis is made by movement of the quill.

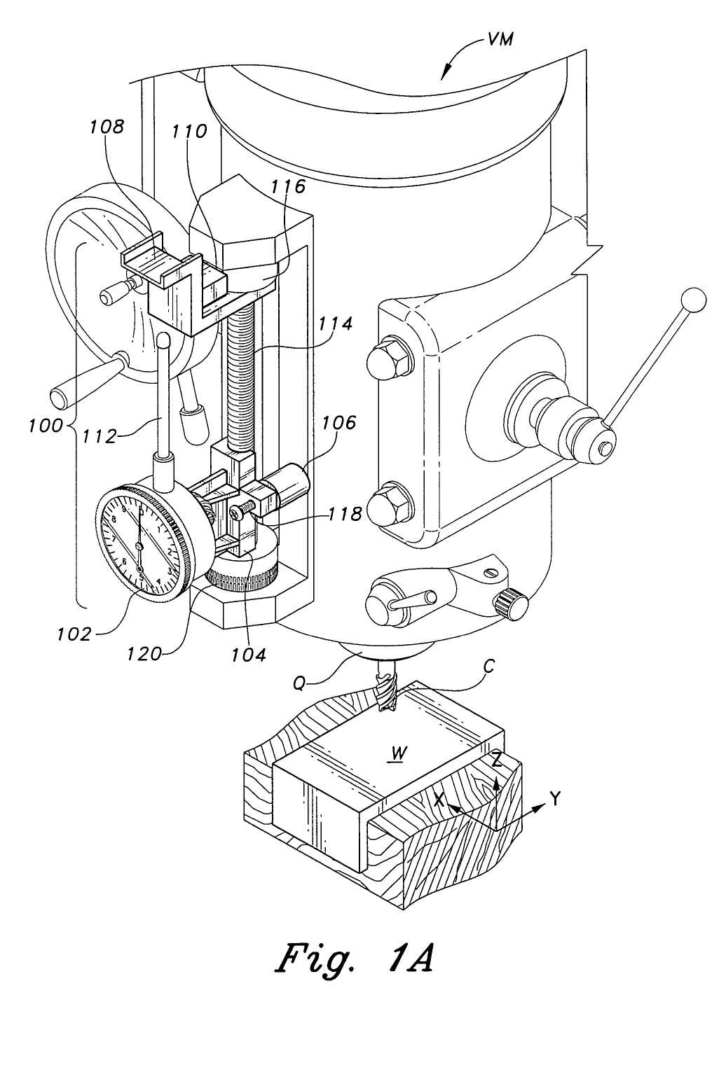

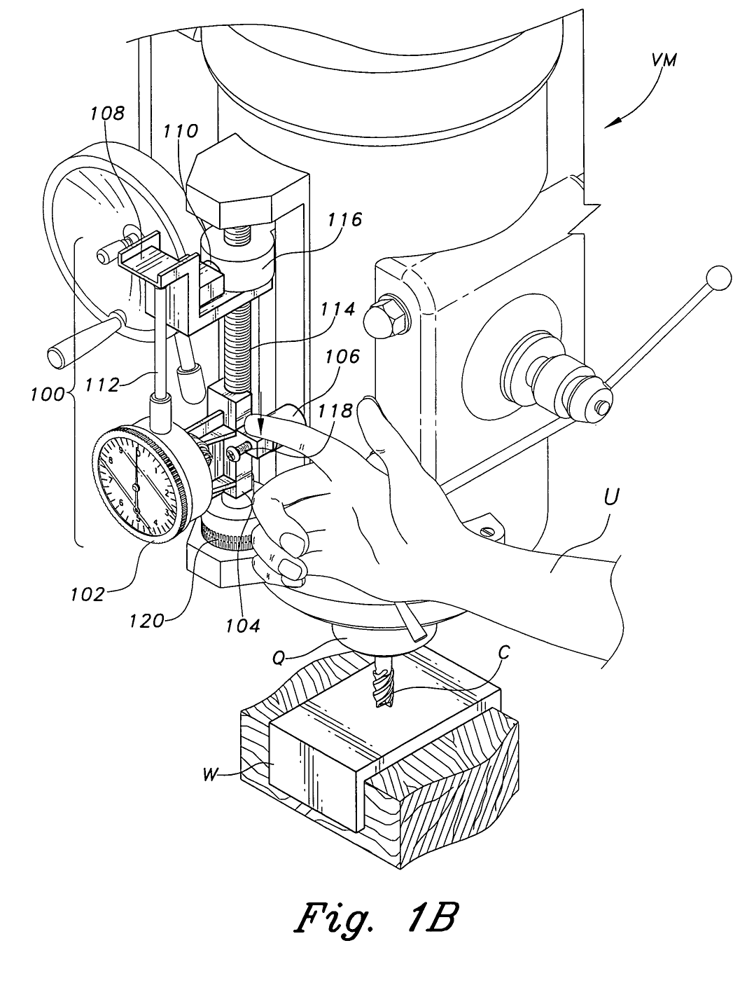

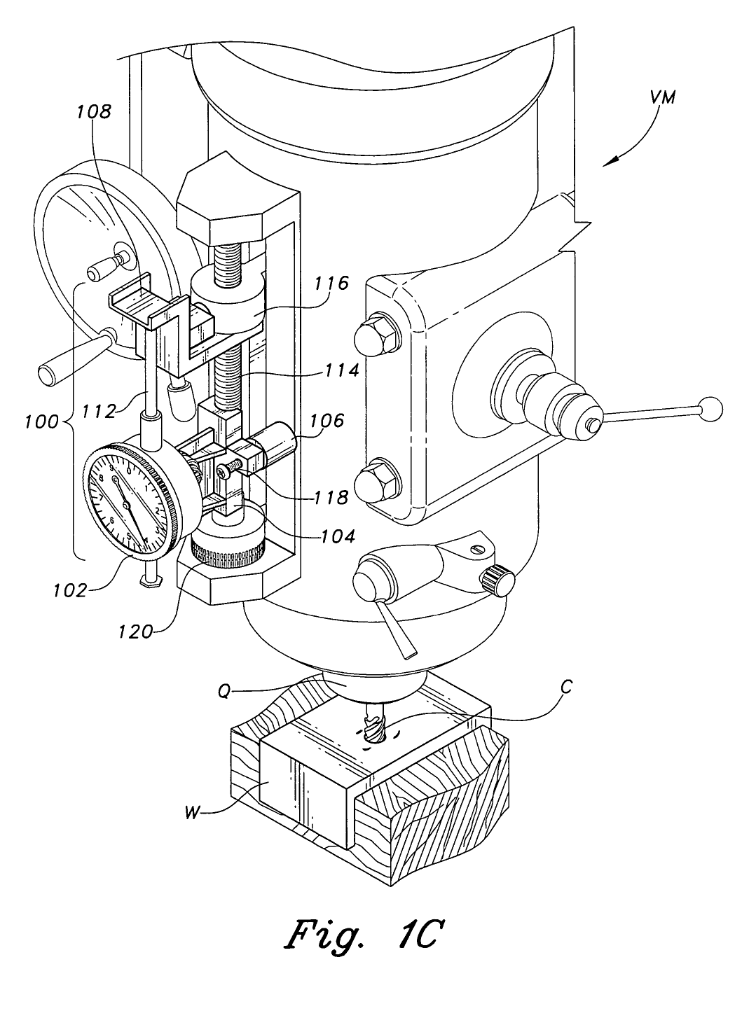

FIGS. 1A-1C show the sequence of steps when using the tool 100 of the present invention to form a precision cut in workpiece W. The tool 100 has two brackets 104, 108 mountable to the milling head of a vertical milling machine VM. Made of polycarbonate or other non-magnetic rigid material, such as plastic or aluminum, the brackets 104, 108 may be machined, cast, molded, extruded, or otherwise formed.

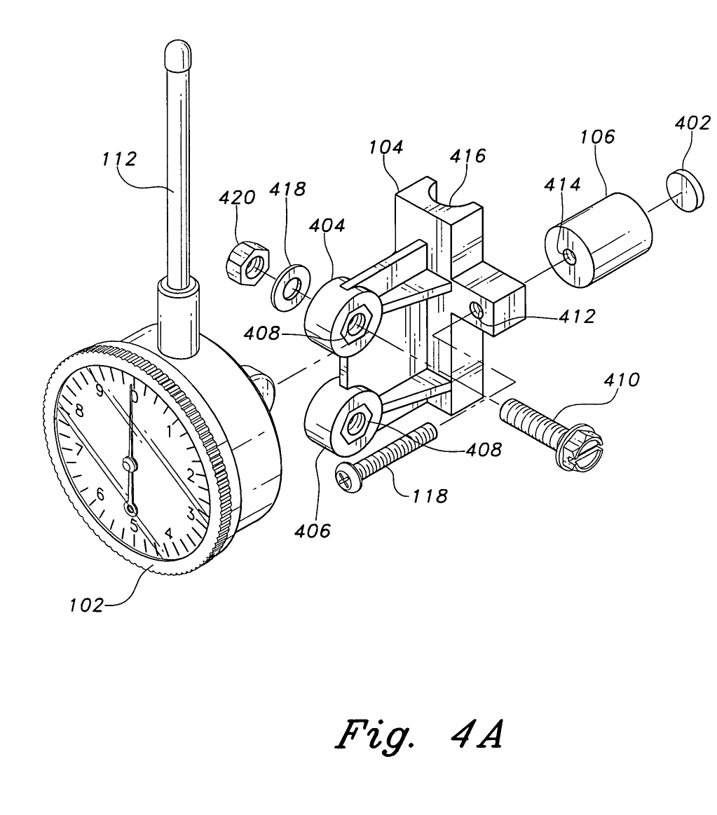

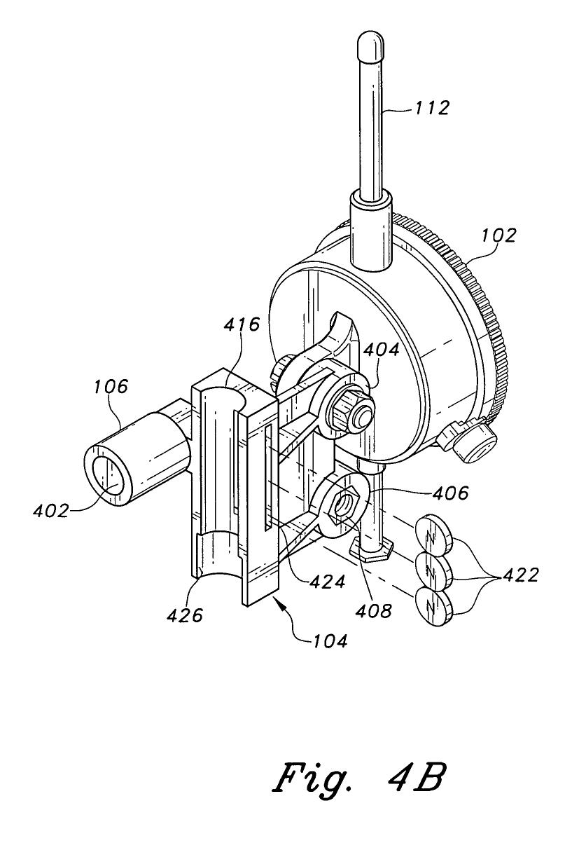

As shown in FIGS. 1A-1C, a commercially available dial indicator 102 is mounted to a first bracket 104, also referred to as dial indicator mounting bracket 104, the bracket 104 being magnetically and slidably attached to an intermediate location along the milling machine's quill stop micro screw 114. Best shown in FIGS. 4A-4B, the dial indicator mounting bracket 104 has a rectangular body approximately 2.5″ tall and 0.75″ wide with a vertically oriented pair of mounting bosses 404, 406 extending from the front of the body and dimensioned for receiving the dial indicator 102. Commonly available in the field of precision measurement, dial indicators incorporate a spindle, which moves in and out from the stem of the indicator and rotates the measuring needle on a dial face via a rack and pinion gear. Dial indicators usually have either a 1″ or 2″ range and are calibrated in increments of 0.001″. A smaller dial reads each revolution of the larger dial in increments of 0.100″.

The dial indicator 102 used in the present invention 100 is an AGD2 or AGD1 (meets American Gage Design [AGD] specifications) precision dial indicator, wherein one revolution of the dial is 0.100″, the difference between the two models being the range of measured displacement. The AGD2 incorporates a spindle 112 having two inches of travel, and the AGD1 may be used where precision cuts less than one inch are required. Not limited to any specific dial indicator, any commercially available dial indicator may be incorporated in the present invention 100.

Most dial indicators have mounting hardware or lugs by which the device 102 may be mounted to one of two mounting bosses 404, 406 on the dial indicator mounting bracket 104. The upper mounting boss 404 is used with the AGD1, and the lower mounting boss 406 is used with an AGD2 dial indicator. Each mounting boss 404, 406 has a threaded sleeve 408 secured therein that receives a ¼×20 mounting bolt 410, which secures the dial indicator 102 to the bracket 104. Although threaded sleeves 408 may be used in each mounting boss, especially when using plastic molded brackets, other fastening means may be incorporated include internal threads defined in the boss itself when the bracket is made from metal, or a boss having a smooth bore used in combination with standard nut and washer hardware 420, 418.

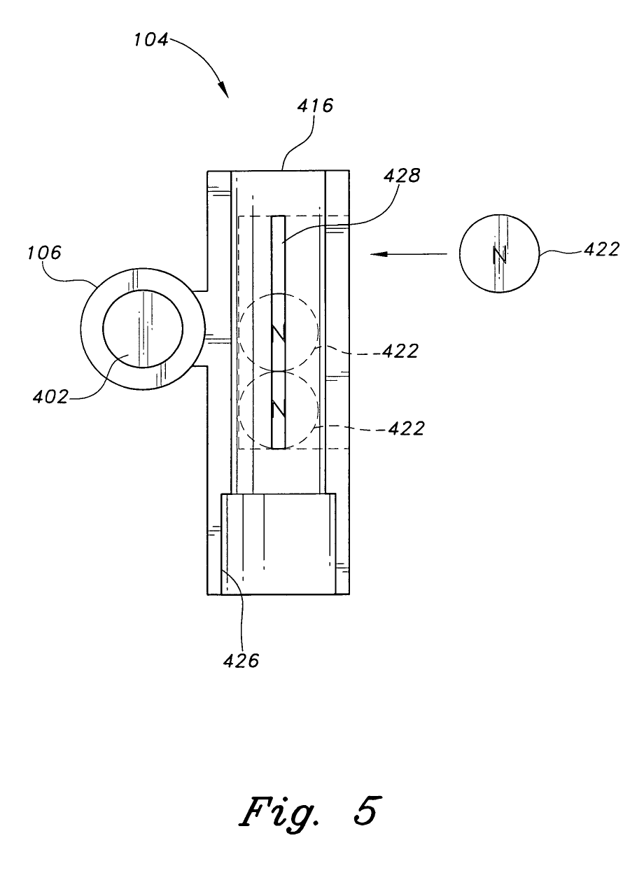

As best shown in FIG. 4B, the dial indicator mounting bracket 104 has an vertical arcuate channel 416 defined therein, disposed opposite mounting bosses 404 and 406. The shape of the channel 416 is dimensioned to receive a portion of the lateral surface of the elongated quill stop micro screw 114 shown in FIGS. 1A-1C. The bracket 104 is secured to the metallic screw 114 by means of three disk magnets 422 inserted into a slot 424 defined in a lateral side of the bracket 104. The magnets 422 are neodymium iron boron (NdFeB) magnets, commonly referred to as “neodymium” or “rare earth” magnets, which provide stronger magnetic attachment then conventional iron magnets. The magnets 422, each of which are 0.5″ in diameter and 0.125″ thick, are vertically aligned and have their respective north and south poles facing in the same direction. The slot 424 in the bracket 104 is positioned along the side of the bracket 104 and extends under the channel 416 along its longitudinal midline, the channel 416 having a long narrow opening 428 defined along the midline, as shown in FIG. 5. Wedged tightly into slot 424, the magnets 422 are in magnetic contact with the quill stop micro screw 114 through the opening 428 in the wall of the channel 416. The lower portion of the channel 426 is cut with a greater radius of curvature than the rest of the channel 416, and is dimensioned to cooperatively engage the upper portion 602 of the micrometer-adjusting nut 120 should the dial indicator mounting bracket 104 be positioned at the base of the micrometer adjustment nut 120.

An adjustable magnetic stabilizer arm 106 extends from a lateral surface of the dial indicator mounting bracket 104 and magnetically attaches to the front facing flat metallic surface 122 of the milling machine VM. As shown in FIGS. 1A and 1B, the stabilizer arm 106 is designed to prevent the dial indicator mounting bracket 104 from rotating or shifting. The stabilizer arm 106 has a rare earth disk magnet 402, similar to that used in slot 424, seated in the head of stabilizer arm 106. The stabilizer arm 106 is adjustably mounted to a lug extending laterally from the bracket 104 by means of a 10×32 threaded bolt 118 passing through the threaded aperture 412 and received by threaded recess 414 in the stabilizer arm 106. In addition to preventing rotation around micro screw 114, the stabilizer arm 106 is also used during zeroing of the dial indicator 102, as described below.

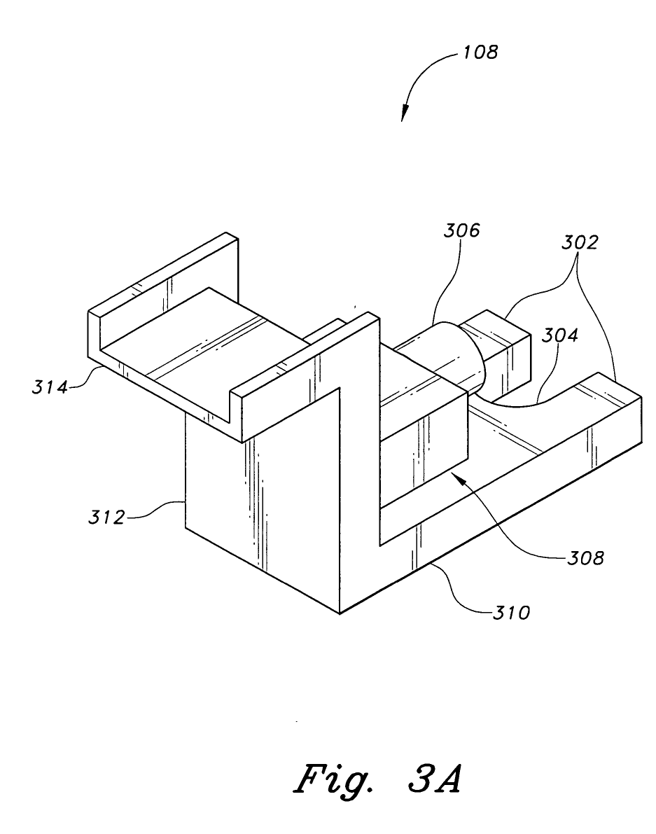

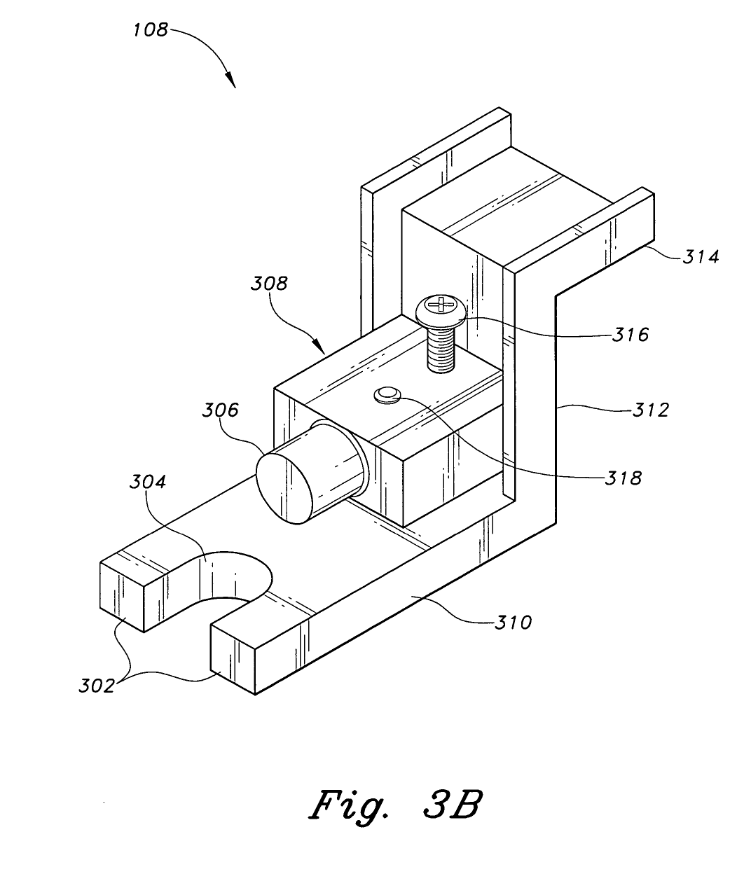

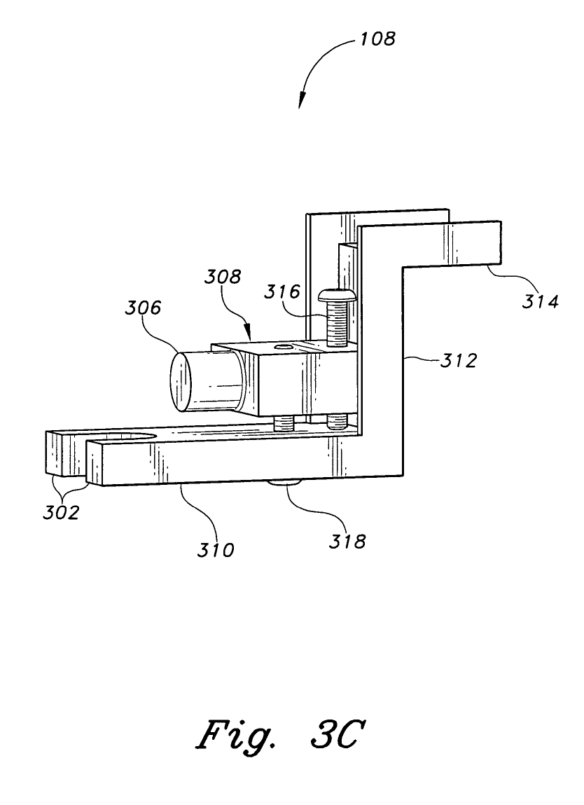

A second bracket, or travel bar, designated as 108 in the drawings and shown in detail in FIGS. 3A-3C, is removably mounted to the quill stop 116 of the vertical milling machine VM above the dial indicator mounting bracket 104. Referring again to FIG. 6, the vertical milling machine VM is designed so that quill stop 116 encircles, but does not engage quill stop micro screw 114, thereby allowing the quill stop 116 to travel vertically in tandem with the quill Q. As previously explained, in normal operation of a standard milling machine, the downward travel of quill stop 116 is arrested by micrometer adjusting nut 120 when the cutter C has penetrated to a user determined depth into the workpiece W, as determined by the vertical position of the threadably adjustable adjusting nut 120 along screw 114. The present invention 100 uses the quill stop 116 and the quill stop micro screw 114 as mounting points for brackets 108 and 104 respectively.

Referring back to FIGS. 3A-3C, travel bar 108 is attached to the quill stop 116 by means of a pinch block 308 having a cylindrical stud 306 approximately 0.5″ in diameter, which is received by a bore 604 (best seen in FIG. 6) typically provided in the quill stop 116 of most commercially available milling machines. The travel bar 108, comprised of polycarbonate, aluminum or other rigid material, has a longitudinal base or lower member 310 approximately 2″ long, having a front end and a rear end, the front end being connected to a vertical member 312 approximately 1.5 inches high. The rear end of lower member 310 is bifurcated to form a pair of legs 302 extending from the rear of lower member 310, defining a “U” shaped notch 304 that engages quill stop micro screw 114. The pinch block 308 is adjustably mounted above the upper surface of the longitudinal lower member 310 by a pair of set screws 316, 318. Proper adjustment of the setscrews 316, 318 applies a compressive force between legs 302 and stud 306, thereby securing travel bar 108 to the quill stop 116. The width of the U-shaped notch 304 is greater than the diameter of micro screw 114, so that legs 302 do not rub against micro screw 114 when the quill stop 116 is raised or lowered.

Extending forward from the upper end of the vertical member 312 is an upper longitudinal member or ledge 314 having a flat lower surface. When the travel bar 108 is mounted to the quill stop 116, the flat lower surface of the upper member 314 is aligned with spindle 112 extending upwards from the dial indicator 102, so that the lower surface of upper member 314 bears against the contact tip of the spindle 112 when the quill is lowered to the appropriate height.

Referring back to FIG. 1A, operation of the Z-axis measurement tool requires that the travel bar 108 be secured to the stop quill 116, and that the dial indicator mounting bracket 104, with attached dial indicator 102, be magnetically fastened to the bottom of the quill stop micro screw 114.

As shown in FIG. 1B, the cutting edge C is lowered to the surface of workpiece W and dial indicator mounting bracket 104 is raised up micro screw 114 until spindle 112 abuts and bears against the lower surface of upper member 314 of travel bar 108 and the dial indicator depth gage 102 shows some positive reading. Although the three rare earth magnets 422 disposed within the body of bracket 104 and the fourth magnet 402 within stabilizer bar 106 are sufficiently powerful to secure the bracket 104 to the vertical milling machine VM, user U is able to tap dial stabilizer arm 104 in a downward direction, relieving the force exerted on spindle 112 until the dial indicator 102 is zeroed. At this point the Z-axis measurement tool 100 has been “zeroed” with respect to the cutting edge C and workpiece W.

Further downward travel of the cutting edge C and quill Q results in penetration of the workpiece W to a depth registered on the dial indicator 102 as a result of the travel bar 108 depressing the spindle 112 of the dial indicator 102. By virtue of the dial indicator 102 being mounted to a stationary and visually accessible portion of the vertical milling machine VM, a user can easily monitor the indicia on the dial indicator 102, thereby controlling with precision the Z-axis displacement of the quill Q of a vertical milling machine VM.

It is to be understood that the present invention is not limited to the embodiment described above, but encompasses any and all embodiments within the scope of the following claims.

1. A Z-axis measurement tool for use with vertical milling machines having a quill stop and a vertical quill stop micro screw, the measurement tool comprising:
a dial indicator mounting bracket having at least one disk magnet embedded therein and at least one vertically spaced gage-mounting boss adapted for receiving a dial indicator depth gage, the mounting bracket being adapted for magnetic mounting to the quill stop micro screw; and
a travel bar adapted for mounting to the quill stop above the dial indicator mounting bracket, the travel bar having at least one horizontal member with a downward facing flat abutment surface defined on said extending horizontal member;
wherein the abutment surface is adapted for depressing a spindle of an inverted dial indicator depth gage when the travel bar is mounted in vertical alignment over the mounting bracket and the quill stop is lowered.

2. The Z-axis measurement tool according to claim 1, further comprising a depth gage mounted on said mounting bracket, the depth gage having a dial, a stem extending from the dial, and a spindle movable spindle extending from the stem, the depth gage being inverted so that the spindle abuts the abutment surface of said travel bar when the quill stop is lowered.

3. The Z-axis measurement tool according to claim 1, wherein said mounting bracket has a vertically oriented arcuate channel defined therein.

4. The tool according to claim 3, wherein mounting bracket has a lateral surface having a horizontal slot defined therein, the slot extending below the channel, the channel having an opening defined therein extending axially along a midline of the channel and communicating with the slot, whereby a portion the channel is open to the slot.

5. The Z-axis measurement tool according to claim 4, wherein said at least one magnet is slidably inserted within the slot defined in said mounting bracket, whereby at least a portion of said at least one magnet is below the opening in the channel.

6. The Z-axis measurement tool according to claim 5, wherein said at least one magnet is a rare earth magnet.

7. The Z-axis measurement tool according to claim 1, wherein said at least one vertically spaced gage-mounting boss has a threaded sleeve disposed therein.

8. The tool according to claim 1, wherein said first bracket has an adjustable stabilizer bar and a magnet embedded therein.

9. The tool according to claim 1, wherein said travel bar further includes:
a first longitudinal member having a top surface, a bottom surface, a first end and a second end, the second end being bifurcated and defining a pair of coplanar legs and a U-shaped recess between the legs;
a vertical member extending upward from the first end of the first longitudinal member, the vertical member having an upper end, said at least one horizontal member extending from the upper end of the vertical member in a direction opposite to the first longitudinal member;
a pinch block adjustably mounted above the upper surface of said first longitudinal member; and
a cylindrical stud extending from said pinch block in the direction of the U-shaped recess, the stud being adapted for being received in a bore defined in the quill stop.

10. The Z-axis measurement tool according to claim 1, wherein said mounting bracket and said travel bar are made of non-magnetic rigid material.

11. A “Z”-axis measurement tool for use with vertical milling machines having a quill stop and a vertical quill stop micro screw, the measurement tool comprising:
a dial indicator mounting bracket having at least one magnet attachable to an intermediate position on the vertical quill stop micro screw, and at least one vertically spaced gage-mounting boss;
a travel bar mountable to the quill stop, the travel bar having a horizontal member with a downward facing flat abutment surface, the horizontal member outwardly projecting from the quill stop; and
a dial indicator depth gage mounted on the mounting bracket, the depth gage having an upwardly extending spindle with a contact tip;
wherein the travel bar is disposed vertically above the mounting bracket;
whereby the contact tip of the spindle is aligned with the flat abutment surface of the travel bar.

12. The Z-axis measurement tool according to claim 11, wherein said mounting bracket has a vertically oriented channel defined therein.

13. The Z-axis measurement tool according to claim 12, wherein said mounting bracket has a lateral surface with a horizontal slot defined therein, the slot extending below the channel, the channel having an opening defined therein extending along an axial midline of the channel and communicating with the slot.

14. The tool according to claim 13, wherein said at least one magnet is slidably inserted within the slot in said mounting bracket, whereby at least a portion of said at least one magnet is below the opening in the channel.

15. The tool according to claim 11, wherein said at least one magnet is a rare earth magnet.

16. A method of accurately measuring Z-axis displacement of a vertical milling machine quill, comprising the steps of:
slidably and magnetically mounting a dial indicator mounting bracket having an attached dial indicator to a quill stop micro screw of said vertical milling machine;
fixedly mounting a travel having a flat abutment surface to a quill stop of said vertical milling machine;
vertically positioning the quill of said vertical milling machine so as to abut the surface of a workpiece; and
sliding said mounting bracket in order to position a contact tip of a spindle of said dial indicator against the flat abutment surface of said travel bar;
whereby any further downward travel of said quill is registered on said dial indicator.
